(19) United States
(12) Patent Application Publication
(10) Pub. No.: US 2002/0018738 A1
(43) Pub. Date: Feb. 14, 2002

(54) Pulsed flow preferential oxidation reactor

(76) Inventors: Richard Woods, Long Beach, CA (US); Shawn Barge, Long Beach, CA (US)

Correspondence Address: COLIN P ABRAHAMS, 5850 CANOGA AVENUE, SUITE 400, WOODLAND HILLS, CA, 91367

(21) Appl. No.: 09/827,258

(22) Filed: Apr. 5, 2001

Related U.S. Application Data
(60) Provisional application No. 60/194,713, filed on Apr. 5, 2000.

(51) Int. Cl. B01J 8/00

(52) U.S. Cl. 422/189; 422/190; 422/194; 422/198; 422/211

(57) ABSTRACT

A multi-stage preferential oxidation reactor for removing carbon-monoxide from a product-gas comprises at least one preferential oxidation reactor stage having a product-gas stream inlet end and a product-gas stream outlet end. A first inlet is provided to introduce the product-gas stream into the preferential oxidation reactor stage, and is located at the product-gas stream inlet end of the preferential oxidation reactor stage. The first inlet is configured with a pulsator for pulsing the flow of the product-gas stream into the preferential oxidation reactor stage. A second inlet is also provided to introduce an oxidant into the preferential oxidation reactor stage. The second inlet is located at the product-gas stream inlet end of the oxidizer preferential oxidation reactor stage. An outlet is provided for removal of the treated product-gas stream from the preferential oxidation reactor stage.

### CROSS REFERENCE TO RELATED APPLICATIONS

This application claims the benefit of U.S. Provisional application No. 60/194,713 filed Apr. 5, 2000.

### FIELD OF THE INVENTION

The field of the invention is fuel-gas production for fuel-cells.

### BACKGROUND OF THE INVENTION

Current state of the art fuel cells are generally powered by reformer gas production units, which produce a fuel-gas from commonly available hydrocarbon fuels and a oxidant such as air. The reformer gas production units generally consist of an auto-thermal reactor, a high temperature shift reactor, and a low temperature shift reactor. The fuel gas produced by such units is usually a mixture of hydrogen, carbon-dioxide, nitrogen, water with traces of carbon-monoxide and unreacted hydrocarbon fuel.

Fuel cells are generally sensitive to the presence of carbon-monoxide in the fuel-gas stream as it tends to attack the anode of fuel-cell and starve it of hydrogen and thereby reduce the electrical power output capacity of the fuel cell.

To mitigate this situation, Preferential Oxidation Catalytic reactors are generally provided downstream of the low temperature shift reactor of the reformer production units. The Preferential Oxidation Catalyst in these reactors preferentially oxidizes the carbon-monoxide to a negligible level while generally not affecting the hydrogen in the process stream. While most of the carbon-monoxide is oxidized, a small quantity of hydrogen is also oxidized. Thus the PROX catalyst creates an essentially carbon-monoxide free fuel gas. However, the PROX catalyst also reduces the hydrogen producing capacity of the reformer gas production unit because of the side-reactions that oxidize the hydrogen to water. Further since only a finite quantity of PROX catalyst can be economically used, there is still a very small amount of carbon-monoxide which is not converted in the PROX catalyst. This carbon-monoxide eventually affects the operation of the fuel-cell.

Therefore it a desired goal of PROX reactor designers to create a PROX reactor wherein the amount of hydrogen consumed by the side-reaction is minimized and wherein the quantity of unoxidized carbon-monoxide is also minimized.

### SUMMARY OF THE INVENTION

Accordingly, this invention is for a process and apparatus for a preferential oxidation (PROX) reactor wherein the amount of hydrogen consumed is minimized and wherein the amount of carbon-monoxide that is oxidized is maximized to produce an essentially carbon-monoxide free fuel-gas for the fuel cell. The invention achieves these goals by introducing feed-gas components to the PROX reactor in a cyclically pulsating manner. In one form, the invention uses a pulsed oxidant or air-feed to a preferential oxidation (PROX) carbon monoxide (CO) polishing unit. The invention has, as one of its benefits, the enhancement of the efficiency of such a unit by maximizing the selectivity thereof to carbon monoxide (CO) over hydrogen. In other words, by pulsating the flow of the oxidant, the preference for the carbon-monoxide oxidation reaction versus the hydrogen oxidation reaction is enhanced resulting in a fuel-gas stream which has a higher hydrogen concentration and a lower carbon-monoxide concentration than is achievable with currently available PROX reactors.

The improved selectivity using a preferential oxidation catalyst in favor of CO oxidation over hydrogen oxidation is achieved by the independent control of the oxygen reaction on the surface of the catalyst, and the thermal wave created by the pulsed introduction of the oxidant.

The invention also allows the PROX reactor designer the ability to change the concentration of hydrogen in the product gas. This ability follows as a consequence of pulse-width modulation of the oxidant into the preferential oxidation reaction. This aspect of the invention, in turn, may improve the carbon monoxide tolerance of a fuel cell due to anode surface area oxidation during low hydrogen concentration periods.

In another form of the invention, the flow of the untreated fuel-gas into the PROX reactor is pulsed to provide essentially the same results described above for the form of the invention which pulses the flow of oxidant.

Thus, the invention allows a low cost, pulse-width modulating wave to be used to control oxidant flow to the preferential oxidation reactor. Moreover, it permits variable speed air compressors with modulating characteristics to be used for both the primary air to an autothermal reformer reactor (ATR), and the secondary air to the preferential oxidation (PROX) reactor.

In one particular aspect, the apparatus and process of the invention has a significant benefit when used with fuel processors in fuel cell applications with PEM (polymer electrolyte membrane) fuel cells.

In further describing the apparatus and method of the invention, reference is now made to the drawings accompanying this application.

### BRIEF DESCRIPTION OF THE DRAWINGS

FIG. 1 shows a diagrammatic representation of a preferential oxidation reactor, which forms part of the state of the art;

FIG. 2 shows a diagrammatic representation of one embodiment comprising a simple single-stage preferential oxidation reactor of the invention;

FIG. 3 shows a two-stage preferential oxidation reactor of the invention;

FIG. 4 illustrates in schematic form a second embodiment of a preferential oxidation reactor of the invention;

FIG. 5 illustrates schematically a variable speed air compressor, which can be used in association with the preferential oxidation reactor of the invention;

FIG. 6 illustrates in schematic form a further configuration of the preferential oxidation reactor of the invention, including an electrochemical reactor;

FIG. 7 illustrates a further configuration of the embodiment shown in FIG. 6; and

FIGS. 8 and 9 illustrate diagrammatically the pulsed oxidant addition effects on the chemical and/or electrochemical reactions at the surface of the catalysts.

### DETAILED DESCRIPTION OF THE INVENTION

With reference to FIG. 1 of the drawings, there is shown a current state of the art multi-stage preferential oxidation reactor 10. In FIG. 1, three stages are shown. However, the number of stages can be any finite number greater than one. In FIG. 1, the MSPROX reactor has a first stage 12, a second stage 14 and a third stage 16. As defined herein, a MSPROX reactor stage consists of three internal functional elements. These three internal functional elements comprise a mixing chamber 18, a heat exchange chamber 20, and a preferential oxidation catalyst chamber 22. The mixing chamber 18, heat exchange chamber 20 and preferential oxidation chamber 22 are arranged serially, with the product gas 24 passing through each of these chambers 18, 20 and 22 in sequence.

As shown in FIG. 1, product gas 24 enters the first stage 12 through line 26, and, in the first stage 12, passes sequentially through the mixing chamber 18, heat exchange chamber 20 and preferential oxidation chamber 22. The product gas 24 then exits the first stage 12 through line 28, and is conveyed through line 28 to the mixing chamber 18 of the second stage 14. After the product gas passes through the mixing chamber 18, heat exchange chamber 20 and preferential oxidation chamber 22 of the second stage 14, it exits the second stage 14 through line 30, through which the product gas is fed to the mixing chamber 18 of the third stage 16. After passing through the third stage 16, the product gas 24 exits through the line 32.

In the multi-stage preferential oxidation reactor 10 shown in FIG. 1, air is also injected into each mixing chamber 18 of the first, second and third stages 12, 14 and 16 respectively. Air is provided from a source to line 34 and travels to each of the mixing chambers 18 through connections 36, 38 and 40. Each connection 36, 38 and 40 includes a control valve 42, 44 and 46 which regulates the air stream between the source and each of the mixing chambers 18.

In current or prior art preferential oxidation reactors, the control valves 42, 44 and 46 are normal, variable, orifice-type control valves that regulate a constant air-bleed into the first, second and third stages 12, 14 and 16 of the preferential oxidation reactor 10. By adjusting these control valves 42, 44 and 46, the flow rate of air may be increased or decreased with respect to the operating unit capacity and/or the concentration of carbon monoxide entering the reactor. Oxygen that is fed to the reactor and that is not used for the oxidation of carbon monoxide (CO) will typically react with hydrogen in the product gas.

Catalysts used in the reactor of the invention, and having a better performance, are those with a higher selectivity to carbon monoxide, or which preferentially react with carbon monoxide over hydrogen. Examples of such catalyst are the Selectoxo (TM) catalysts which consists of 0.3 to 0.5% platinum promoted with a base metal oxide and supported on gamma-alumina tablets. Alternately catalysts having up to 5% platinum promoted by a base metal oxide and impregnated onto gamma-alumina have also been used as Preferential Oxidation catalysts. Further, the active catalyst material has also be coated on monolith structures made of cordierite to provide lower operating pressure resistance than the alumina tablets. Yet other types and configurations of catalysts may also be used without affecting the performance of the PROX reactor. These and other examples of Preferential Oxidation catalysts are well known in the art.

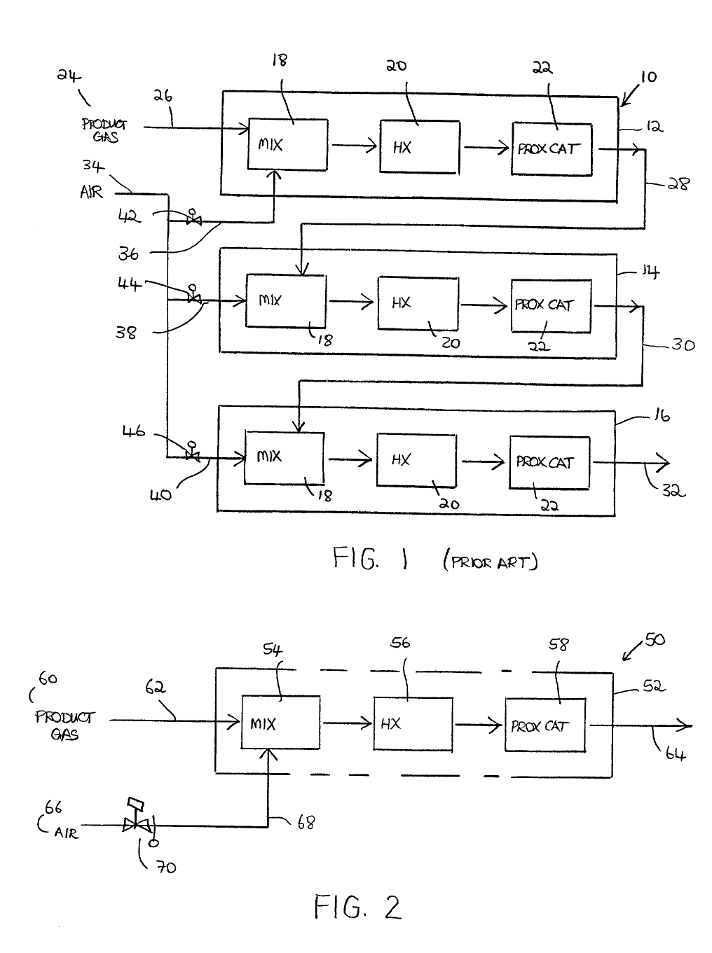

Reference is now made to FIG. 2 of the drawings which shows a preferential oxidation reactor of the invention in schematic form. In FIG. 2, there is shown a simple, single stage preferential oxidation reactor 50 comprising a single-stage 52 which includes a mixing chamber 54, a heat exchange chamber 56 and a preferential oxidation catalyst chamber 58. Product gas 60 is introduced to the single stage 52 through line 62 and passes sequentially through the chambers 54, 56 and 58 after which it exits the reactor through line 64. An air source 66 supplies air through line 68 to the mixing chamber 54 where it is mixed with the product gas 60. The reactor 50 incorporates a pulse width-modulating valve 70, in the line 68, which controls the addition of oxidant to the reactor 50.

Flow control valve 70 can be any standard control valve that is generally used for the control of gas-flow. Thus flow-control valve 70 could be a damper, a butter-fly valve, a plunger-type valve, a needle valve, an adjustable orifice, a slide-gate valve, an adjustable constriction, a rotary valve, or any other means of adjusting flow including a diverter valve which diverts or re-introduces a part of a gas out of or into the system. Such valves are readily available in the US from manufacturers such as Maxon, Eclipse, DeZurik, etc. Flow-control valve 70 can be actuated by any kind of pneumatic, hydraulic, or electrical controller such as a piston, or electric linear motor or an electric rotor. Cam means can also be used to convert the steady rotary action of an electrical motor or steam turbine into a cyclically unbalanced rotary action to cyclically move the flow-restricting element in the valve between a pre-determined range of positions and provide an oscillatory flow pattern in the valve. Such controllers and cam means are readily available in the US from manufacturers such as Barber-Colman, Honeywell, Kinetrol, etc.

While the above description indicates that the oxidant flow is being pulsed while the flow of the untreated fuel gas is being kept relatively constant, the present invention can also be practiced by pulsing any one of the untreated gas stream and keeping the flow of the oxidant to achieve substantially the same results as described above.

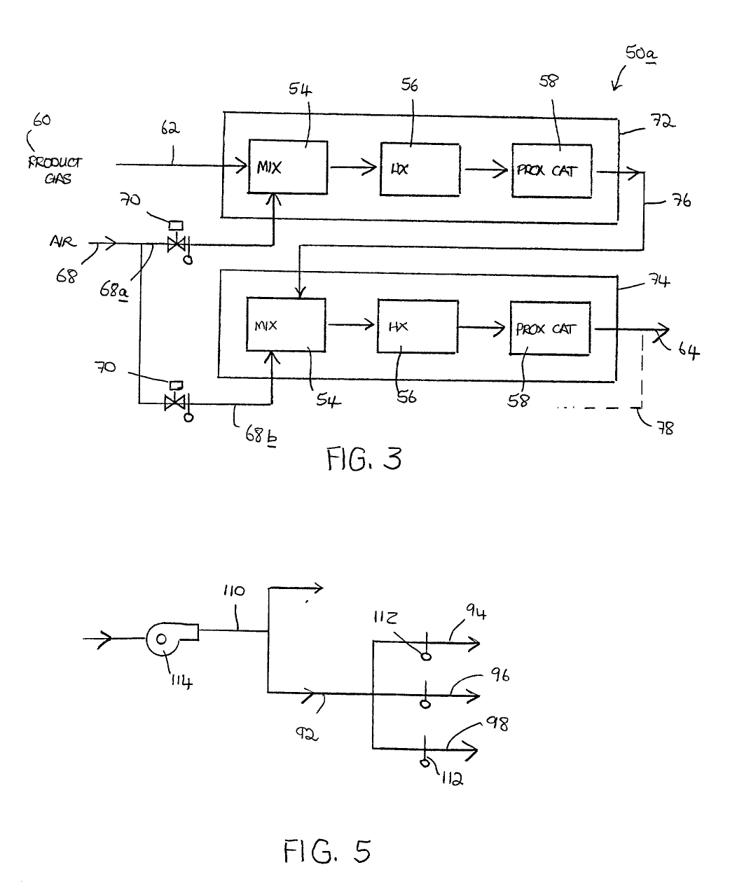

FIG. 3 of the drawings shows a Preferential Oxidation reactor, which is very similar to the embodiment shown in FIG. 2, except that the reactor 50a consists of a first stage 72 and a second stage 74, and shows an arrangement whereby lines 68a and 68b, through which air is conveyed to the mixing chambers 54, incorporate pulse width-modulating valves 70. In FIG. 2, the pulse width-modulating valve 70 is used to control the oxidant addition to the single stage 56 of the reactor 50, while, in FIG. 3, two such pulse width-modulating valves 70 in lines 68a and 68b respectively are used to control the addition of oxidants to the first stage 72 and second stage 74 of the reactor 50a. The control of these valves 70 can be tuned to minimize and/or maximize the pulsed effect on the hydrogen concentration in the product gas composition exiting the reactor through line 64.

With reference to the embodiment shown in FIG. 3, it will be appreciated that additional stages may be provided. Line 76 conveys the product gas from the first stage 72 to the second stage 74. In FIG. 3, the product exits the second stage 74 through line 64. However, instead of exiting the reactor through line 64, additional stages, not illustrated, may be provided, and the product gas would be fed to the next stage after the second stage 74 illustrated in FIG. 3 by the line 78 shown in phantom.

Reference is now made to FIG. 4 of the drawings, which shows yet a further embodiment of the preferential oxidation reactor of the invention. In FIG. 4, preferential oxidation reactor 50b has three stages, namely, first stage 80, second stage 82 and third stage 84. Each of these stages 80, 82 and 84 includes therein a mixing chamber 86, a heat exchange chamber 88 and a preferential oxidation catalyst chamber 90, in the same way as has been described with respect to the earlier embodiments. In the reactor 50b, air from a source 92 separates into feed lines 94, 96 and 98 which supply air to the first, second and third stages respectively. Product gas 100 is introduced to the first stage 80, passing sequentially through the chambers 86, 88 and 90. The product gas exits through line 102, and is fed into the second stage 82. Line 104 conveys the product gas from the second stage 82 to the third stage 84. At the end of the third stage 84, the product gasses exit through line 106.

The reactor 50b includes a single pulse width-modulating valve 108 in line 110, which ultimately supplies feed lines 94, 96 and 98 to the three stages of the reactor 50b. Air in the line 110 passes through the valve 108, and thereafter into each of the feed lines 94, 96 and 98. In each of the feed lines 94, 96 and 98, there is provided a fixed-flow control orifice 112. Fixed flow orifices are generally restricted openings that are installed in the path of flow of a gas in a conduit to reduce the volumetric flow capacity of the conduit. Such orifices are well known in the art and are commercially available in the US from manufacturers such as North American Combustion Co. and others.

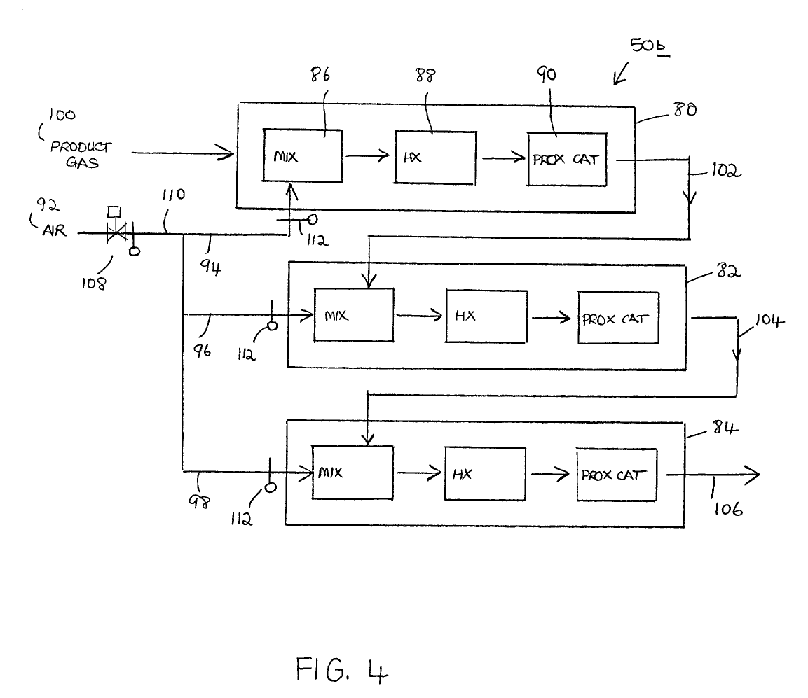

FIG. 5 shows a further embodiment of a Preferential Oxidation reactor, which is a variation of that shown in FIG. 4. In FIG. 5, a variable-speed air blower 114 is provided in line 110 in order to create pressure pulses in the feed lines or supply lines 94 and 96. Such a blower could be a centrifugal compressor or blower, which is driven by an electric motor connected to a variable speed drive. Alternately, the blower could also be connected to an internal combustion engine with a variable governor for automatically modulating the shaft speed between a specified range. Alternately, a piston compressor connected to a variable speed motor or internal combustion engine could also be used to provide a cyclically modulated flow of oxidant to the Preferential Oxidation reactor.

In both of the embodiments of FIGS. 4 and 5, the variable speed air compressor creates pressure pulses in the supply lines. The supply lines, are connected to the feed lines, such that they feed fixed-flow control orifices which in turn feed the preferential oxidation reactor, and the multiple stages therein, where applicable.

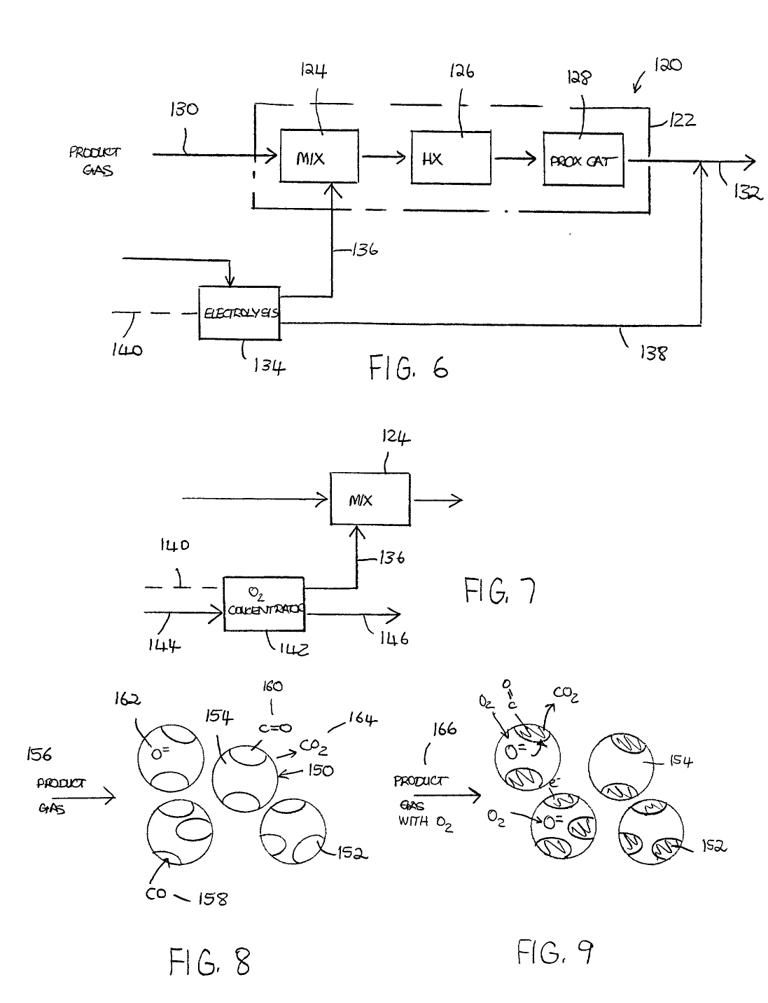

FIGS. 6 and 7 of the drawings illustrate additional embodiments or configurations of the invention. With reference to FIG. 6, there is shown a preferential oxidation reactor 120 having a single stage 122, including the mixing chamber 124, heat exchange chamber 126 and preferential oxidation catalyst chamber 128. Product gas enters the single stage 122, passing through chambers 124, 126 and 128. The product gas enters the single stage 122 through line 130, and exits the reactor through line 132. FIG. 6 illustrates the presence of an electrochemical reactor 134 which can be operated as a water electrolysis-type reactor generating an oxygen stream through line 136 and a hydrogen stream through line 138. Such electrolysis reactors generally consist of an anode and a cathode which are immersed in an aqueous solution of alkali. A direct current is passed through the solution to decompose the water in the solution to hydrogen and oxygen. The theory and practice of producing essentially pure hydrogen and oxygen from the electrolytic decomposition of water is well known in the art. Power is supplied to the electrochemical reactor 134 through power feed 140, and the power can be pulsed into the electro-chemical reactor 134 to create the pulsed oxygen flow in connection or line 136.

FIG. 7 shows a slight alternative to the embodiment shown in FIG. 6, where the electro-chemical reactor operates as an oxygen concentrator 142 which generates an oxygen stream in line 136 by preferentially separating the consuming oxygen from air flowing through connector 144 which is in communication with a source of air supply to provide a relatively oxygen-rich air stream which is supplied to mixing chamber 124 through line 136. The connector 146 in FIG. 7 represents an exhaust of air wherein the oxygen has been depleted. Therefore it contains less oxygen that the air supply entering through connector 144. In both examples shown, in FIGS. 6 and 7, the power can be pulsed or not pulsed to create the source of oxygen being fed to the preferential oxidation reactor 120. Examples of such oxygen concentrators are the Generon (TM) system available in the US from Dupont Inc. Yet other types of oxygen concentrators such as molecular sieves or pressure-swing adsorption systems could also be used to provide a relatively rich oxygen stream to the oxidant.

Although only a single stage 122 is shown in the preferential oxidation reactor 120 shown in FIG. 6, it is within the scope of the invention to have multiple stages according to system requirements.

Reference is now made to FIGS. 8 and 9 of the drawings, which illustrate in diagrammatic form how the pulsed oxidant addition affects the chemical and/or electrochemical reaction on the surface of the catalysts. The preferential oxidation catalyst is represented by reference numeral 150, and, in the particular embodiment under description, is one that consists of a metal carbon monoxide (CO) reacting catalyst 152 mounted on an oxygen reacting ceramic structure 154. As shown in FIG. 8, product gas 156 containing hydrogen, carbon monoxide, carbon dioxide, water and nitrogen, and which is deficient in oxygen, enters the catalyst bed. The carbon monoxide molecules 158 in product gas 156 adsorb to the catalyst surfaces 152. Upon adsorption, these CO molecules, now referenced 160 can remain adsorbed, or can react with oxygen ions 162 which are stored within the ceramic structure 154 to form carbon dioxide, indicated by reference numeral 164. These carbon dioxide molecules 164 may then be released from the catalyst sites.

In the embodiment shown in FIG. 9, product gas 166 is introduced to the system, with the product gas being enriched with oxygen from the pulsed width-modulation valves, of the type described above. The product gas may comprise hydrogen, carbon monoxide, carbon dioxide, water and steam, nitrogen and oxygen. The oxygen molecules in the product gas react with the ceramic structure 154 to form oxygen ions 162, and these ions are stored in the ceramic structure 154. These oxygen ions 162 can then react with adsorbed carbon monoxide (CO) 160 to form carbon dioxide (CO2) 164. The overall chemical reaction can be described as set forth below.

Overall reaction: 1/202+CO - - ->CO2

At ceramic surface: 1/202+2e- - - ->O═

At metal catalyst surface: CO+O═- - ->CO2+2e-

The reactions occur as two half-cell electrochemical reactions, as described above. These reactions include electronic conduction in the ceramic or the transfer of negatively charged electrons. These reactions also include ionic conduction or the transfer of negatively charged oxygen ions. Since there is an electronic as well as an ionic exchange between the two reaction sites, the ceramic support structure should be a mixed conducting ceramic in the fuel-rich environment of the fuel processor's product gas, 156 and 166. Cerium based ceramics, such as Ce2O3, are an example of this type of ceramic which can be used within the context of the present invention.

The invention provides for improved selectivity of the preferential oxidation catalyst, favoring carbon monoxide oxidation over hydrogen oxidation. This is due to the independent control of the oxygen reaction on the surface of the thermal wave created by the pulsed introduction of the oxidant. Another advantage of the invention is the ability to change the concentration of hydrogen in the product gas as a result of pulse-width modulation of the oxidant into the preferential oxidation catalyst. This ability improves CO tolerance of the fuel cell due to anode surface area oxidation during the low hydrogen concentration period.

The invention also allows for a low cost, pulse-width modulating valve to be used to control the oxidant flow to the preferential oxidation reactor. It also allows variable speed air compressors with modulating characteristics to be used for both the primary air to the autothermal reformer reactor and the secondary air to the preferential oxidation rector.

The invention is therefore concerned with the process of pulsing oxidant flow to the preferential oxidation reactors, as opposed to a constant oxidant flow, and the apparatus for achieving this process. The invention also relates to the use of the pulse-width modulating valves to feed air or oxygen to a preferential oxidation reactor. A single pulse-width modulating valve may be used to feed air or oxidant to the various stages of a multi-stage preferential oxidation reactor in various forms and combinations. Additionally, an electrochemical reactor may be used, such as an oxygen concentrator, or a water electrolysis reactor, in order to meter oxidant into the preferential oxidation reaction catalyst. The invention contemplates the use of operating the reactor in both a pulsed and a non-pulsed manner. The use of the variable speed air compressors creates pulsed air flow into the preferential oxidation reactor.

Further, as disclosed previously, it would be obvious to one of ordinary skill in the art to utilize the flow pulsating mechanisms for pulsating the flow of product gas into the reactor to produce essentially the same results as described above by pulsating the flow of oxidant into the reactor. For example in FIG. 1, line 26 could be provided with a pulsing flow element similar to flow elements 42, 44 or 46 in oxidant lines 36, 38, or 40. Similarly, a variable blower such as that represented as 114 in FIG. 5 could also be used to pulsate the flow in of the product gas. Such variations to provide a pulsating flow are well known and will fall within the scope of the invention, which should be evaluated with respect to the following claims.

1. A Multi-Stage Preferential Oxidation reactor for substantially removing carbon-monoxide from a product-gas, said reactor comprising:
at least one Preferential Oxidation Reactor Stage having a product-gas stream inlet end and a product-gas stream outlet end;
a first inlet means to introduce the product-gas stream into said Preferential Oxidation Reactor Stage, said inlet means located at the product-gas stream inlet end of said Preferential Oxidation Reactor Stage, said first inlet means further configured with a means to pulsate the flow of said product-gas stream into said Preferential Oxidation Reactor Stage;
a second inlet means to introduce an oxidant into said Preferential Oxidation Reactor Stage, said second inlet means located at the product-gas stream inlet end of said oxidizer Preferential Oxidation Reactor Stage; and
an outlet means for removal of the treated product-gas stream from said Preferential Oxidation Reactor Stage, said outlet means located at the outlet end of said reactor.

2. The reactor of claim 1 further comprising a second Preferential Oxidation Reactor Stage having a product-gas stream inlet end and a product-gas stream outlet end, said second Preferential Oxidation Reactor Stage further configured with a first inlet means to introduce the product-gas stream into said second Preferential Oxidation Reactor Stage, said first inlet means located at the product-gas stream inlet end of said second Preferential Oxidation Reactor Stage, said second Preferential Oxidation Reactor Stage further configured with a second inlet means to introduce an oxidant into said Preferential Oxidation Reactor Stage, said second inlet means located at the product-gas stream inlet end of said oxidizer Preferential Oxidation Reactor Stage, said second Preferential Oxidation Reactor Stage further configured with an outlet means for removal of the treated product-gas stream from said Preferential Oxidation Reactor Stage, said outlet means located at the outlet end of said second reactor and wherein said first inlet means of said second Preferential Oxidation Reactor Stage receives the treated off-gas from said first Preferential Oxidation Reactor Stage.

3. The reactor of claim 2 further comprising a third Preferential Oxidation Reactor Stage having a product-gas stream inlet end and a product-gas stream outlet end, said third Preferential Oxidation Reactor Stage further configured with a first inlet means to introduce the product-gas stream into said third Preferential Oxidation Reactor Stage, said first inlet means located at the product-gas stream inlet end of said third Preferential Oxidation Reactor Stage, said third Preferential Oxidation Reactor Stage further configured with a second inlet means to introduce an oxidant into said Preferential Oxidation Reactor Stage, said second inlet means located at the product-gas stream inlet end of said oxidizer Preferential Oxidation Reactor Stage, said third Preferential Oxidation Reactor Stage further configured with an outlet means for removal of the treated product-gas stream from said third Preferential Oxidation Reactor Stage, said outlet means located at the outlet end of said third reactor and wherein said first inlet means of said third Preferential Oxidation Reactor Stage receives the treated off-gas from said second Preferential Oxidation Reactor Stage.

4. A Multi-Stage Preferential Oxidation reactor for substantially removing carbon-monoxide from a product-gas, said reactor comprising at least two Preferential Oxidation Reactor Stages, each stage having a product-gas stream inlet end and a product-gas stream outlet end, a first inlet means located at the product-gas stream inlet end of each stage to introduce the product-gas stream into each stage, a second inlet means located at the product-gas stream inlet end of each stage to introduce an oxidant into each stage, an outlet means located at the product-gas stream outlet end of each stage for removal of the treated product-gas stream from each stage, and wherein said first inlet means of the first stage is further configured with a means to pulsate the flow of said product-gas stream into said first stage and wherein each said stage is located in series-flow configuration with respect to the product-gas.

5. A Multi-Stage Preferential Oxidation reactor for substantially removing carbon-monoxide from a product-gas, said reactor comprising at least two Preferential Oxidation Reactor Stages, each stage having a product-gas stream inlet end and a product-gas stream outlet end, a first inlet means located at the product-gas stream inlet end of each stage to introduce the product-gas stream into each stage, a second inlet means located at the product-gas stream inlet end of each stage to introduce an oxidant into each stage, an outlet means located at the product-gas stream outlet end of each stage for removal of the treated product-gas stream from each stage, and wherein each said stage is located in series-flow configuration with respect to the product-gas and in parallel-flow configuration with respect to the oxidant.

6. The reactor of claim 5 wherein said first inlet means of the first stage is further configured with a means to pulsate the flow of said product-gas stream into said first stage.

7. The reactor of claim 5 wherein said second inlet means of each stage is further configured with a means to pulsate the flow of said oxidant into said each stage.

8. The reactor of claim 5 further comprising means to connect said second inlet means of each stage to a common source of oxidant.

9. The reactor of claim 8 further comprising means to pulsate the flow of oxidant from the common source of oxidant.

10. The reactor of claim 6 wherein the means to pulsate the flow of product-gas is a flow-control element.

11. The reactor of claim 10 wherein said flow control element is an actuator-operated flow-control valve whose actuator is cyclically driven between two predetermined positions by a pre-programmed control logic.

12. The reactor of claim 10 wherein said flow control element is an actuator-operated flow-control valve whose actuator is cyclically driven between two predetermined positions by a mechanically linked feed-back system which throttles or opens the flow-control valve in inverse relationship to the pressure of said first feed-gas stream downstream of said flow control element.

13. The reactor of claim 10 wherein said flow control element is a feedback-loop based flow-control valve whose actuator is cyclically driven between two predetermined positions by incorporating a zero-dampening factor in its feed-back control system.

14. The reactor of claim 10 wherein said means to pulsate first feed-gas stream component flow is a rotating gas compressor whose rotational speed is cyclically varied within a pre-determined range of operating rotational speeds.

15. The reactor of claim 10 wherein said means to pulsate first feed-gas stream component flow is a peristaltic flow movement device.

16. The reactor of claim 9 wherein the means to pulsate the flow of oxidant is a flow-control element.

17. The reactor of claim 9 wherein said flow control element is an actuator-operated flow-control valve whose actuator is cyclically driven between two predetermined positions by a pre-programmed control logic.

18. The reactor of claim 9 wherein said flow control element is an actuator-operated flow-control valve whose actuator is cyclically driven between two predetermined positions by a mechanically linked feed-back system which throttles or opens the flow-control valve in inverse relationship to the pressure of said first feed-gas stream downstream of said flow control element.

19. The reactor of claim 9 wherein said flow control element is a feedback-loop based flow-control valve whose actuator is cyclically driven between two predetermined positions by incorporating a zero-dampening factor in its feed-back control system.

20. The reactor of claim 9 wherein said means to pulsate first feed-gas stream component flow is a rotating gas compressor whose rotational speed is cyclically varied within a pre-determined range of operating rotational speeds.

21. The reactor of claim 9 wherein said means to pulsate first feed-gas stream component flow is a peristaltic flow movement device.

22. A method of operating a Preferential Oxidation reactor comprising the steps of:
introducing a product-gas into said reactor;
introducing an oxidant into said reactor;
pulsing the flow of the product gas; and
removing the treated product-gas from said reactor.

23. A method of operating a Preferential Oxidation reactor comprising the steps of:
introducing a product-gas into said reactor;
E introducing an oxidant into said reactor;
pulsing the flow of the oxidant; and
removing the treated product-gas from said reactor.

24. A method of operating a Multi-stage Preferential Oxidation reactor said reactor consisting of at least two Preferential Oxidation Reactor Stages connected in series flow configuration with a product-gas, comprising the steps of:
introducing a product-gas into the first stage of said reactor;
introducing an oxidant into each said reactor stage; Pulsing the flow of the product gas; and
removing the treated product-gas from the last reactor stage.

25. A method of operating a Multi-stage Preferential Oxidation reactor said reactor consisting of at least two Preferential oxidation Reactor Stages connected in parallel flow configuration with an oxidant, comprising the steps of:
introducing a product-gas into the first stage of said reactor;
introducing an oxidant into each said reactor stage; Pulsing the flow of the oxidant into at least one of said reactor stages; and
removing the treated product-gas from the last reactor stage.

26. A method of operating a Multi-stage Preferential Oxidation reactor said reactor consisting of at least two Preferential Oxidation Reactor Stages connected in parallel flow configuration with a common source of an oxidant, comprising the steps of:
introducing a product-gas into the first stage of said reactor;
introducing an oxidant into each said reactor stage; Pulsing the flow of the oxidant from the common source of oxidant; and
removing the treated product-gas from the last reactor stage.
